(19) United States
(12) Patent Application Publication
(10) Pub. No.: US 2023/0004375 A1
(43) Pub. Date: Jan. 5, 2023

(54) VEHICLE-MOUNTED UPDATE DEVICE, PROGRAM, AND PROGRAM UPDATE METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Naoki Adachi, Yokkaichi-shi, Mie (JP)

(21) Appl. No.: 17/756,407

(22) PCT Filed: Nov. 11, 2020
(86) PCT No.: PCT/JP2020/042084

§ 371 Date: May 24, 2022

(30) Foreign Application Priority Data
Nov. 27, 2019 (JP) 2019-214586

(51) Int. Cl. G06F 8/65; G07C 5/00

(52) U.S. Cl. CPC G06F 8/65; G07C 5/008

(57) ABSTRACT

Provided is a vehicle-mounted update device for acquiring an update program transmitted from an external server located outside a vehicle, and performing processing for updating a program of a vehicle-mounted ECU mounted in the vehicle, the vehicle-mounted update device including a control unit for controlling transmission of the update program, and a plurality of communication units to which the vehicle-mounted ECU is connected, and when acquiring the update program, the control unit acquires information regarding a communication unit to which a vehicle-mounted ECU to be updated is connected from the external server, and outputs the update program from the communication unit to which the vehicle-mounted ECU to be updated is connected, based on the acquired information regarding the communication unit to which the vehicle-mounted ECU to be updated is connected.

### CROSS-REFERENCE TO RELATED APPLICATIONS

This application is the U.S. national stage of PCT/JP2020/042084 filed on Nov. 11, 2020, which claims priority of Japanese Patent Application No. JP 2019-214586 filed on Nov. 27, 2019, the contents of which are incorporated herein.

### TECHNICAL FIELD

The present disclosure relates to a vehicle-mounted update device, a program, and a program update method.

### BACKGROUND

ECUs (Electronic Control Units) for controlling vehicle-mounted devices, including, for example, a drive control system for engine control and the like, and a body system for air conditioner control and the like are mounted in a vehicle. Each ECU includes a computational processing unit such as an MPU, a rewritable nonvolatile storage unit such as a RAM, and a communication unit for communicating with other ECUs, and controls the vehicle-mounted devices by loading and executing a control program stored in the storage unit. Furthermore, vehicles are equipped with a communication device that has wireless communication functionality, and can communicate with a program providing device connected to a network outside the vehicle via the communication device, download (receive) a control program of the ECU from the program providing device, and update the control program of the ECU (e.g., see JP 2017-97851A).

In the communication device (relay device) in JP 2017-97851A, when transmitting a downloaded control program to an ECU to be updated, since there is no consideration of suppressing an increase in the traffic (bus load) of a communication line such as a bus to which other ECUs are connected, there is a problem in that processing relating to the update cannot be efficiently performed.

### SUMMARY

An object of the present disclosure is to provide a vehicle-mounted update device and the like with which, when performing processing for updating a control program of a vehicle-mounted ECU, an increase in the traffic of the communication line to which other vehicle-mounted ECUs are connected can be suppressed.

A vehicle-mounted update device according to an aspect of the present disclosure is a vehicle-mounted update device for acquiring an update program transmitted from an external server located outside a vehicle, and performing processing for updating a program of a vehicle-mounted ECU mounted in the vehicle, the vehicle-mounted update device including a control unit configured to control transmission of the update program, and a plurality of communication units to which the vehicle-mounted ECU is connected, and the control unit, when acquiring the update program, acquires information regarding a communication unit to which a vehicle-mounted ECU to be updated is connected from the external server, and outputs the update program from the communication unit to which the vehicle-mounted ECU to be updated is connected, based on the acquired information regarding the communication unit to which the vehicle-mounted ECU to be updated is connected.

### Advantageous Effects of Present Disclosure

According to an aspect of the present disclosure, a vehicle-mounted update device and the like can be provided with which, when performing processing for updating a control program of a vehicle-mounted ECU, an increase in the traffic of the communication line to which other vehicle-mounted ECUs are connected is suppressed.

### BRIEF DESCRIPTION OF DRAWINGS

FIG. 1 is a schematic diagram illustrating a configuration of a vehicle-mounted update system including a vehicle-mounted update device according to a first embodiment.

FIG. 2 is a block diagram illustrating a physical configuration of the vehicle-mounted update device.

FIG. 3 is an illustrative diagram showing an exemplary aspect of identification information of communication units (communication unit identification table).

FIG. 4 is a flowchart illustrating processing performed by a control unit of the vehicle-mounted update device.

FIG. 5 is a flowchart illustrating processing performed by a control unit of a vehicle-mounted update device according to a second embodiment.

FIG. 6 is a flowchart illustrating processing performed by a control unit of a vehicle-mounted update device according to a third embodiment.

### DETAILED DESCRIPTION OF PREFERRED EMBODIMENTS

First, embodiments of the present disclosure will be listed and described. At least some of the embodiments described below may be combined as appropriate.

### First Aspect

A vehicle-mounted update device according to a first aspect of the present disclosure is a vehicle-mounted update device for acquiring an update program transmitted from an external server located outside a vehicle, and performing processing for updating a program of a vehicle-mounted ECU mounted in the vehicle, the vehicle-mounted update device including a control unit configured to control transmission of the update program, and a plurality of communication units to which the vehicle-mounted ECU is connected, and the control unit, when acquiring the update program, acquires information regarding a communication unit to which a vehicle-mounted ECU to be updated is connected from the external server, and outputs the update program from the communication unit to which the vehicle-mounted ECU to be updated is connected, based on the acquired information regarding the communication unit to which the vehicle-mounted ECU to be updated is connected.

With the first aspect, when acquiring the update program from the external server, the vehicle-mounted update device also acquires, from the external server, the information regarding the communication unit to which the vehicle-mounted ECU to be updated serving as the output destination (transmission destination) of the update program is connected. The vehicle-mounted update device outputs the update program from the communication unit to which the vehicle-mounted ECU to be updated is connected, which eliminates the need to output the update program from communication units other than the communication unit to which the vehicle-mounted ECU to be updated is connected. Accordingly, an increase in the traffic (bus load) of the communication line connected to the communication unit can be suppressed, and the update program can be efficiently output (transmitted) to the vehicle-mounted ECU to be updated.

### Second Aspect

A configuration is also possible in which, in the vehicle-mounted update device according to a second aspect of the present disclosure, if the communication unit corresponding to the information regarding the communication unit to which the vehicle-mounted ECU to be update is connected that is acquired from the external server cannot be specified out of the plurality of communication units, the control unit outputs, to the external server, information including a fact that the communication unit to which the vehicle-mounted ECU to be updated is connected cannot be specified.

With the second aspect, when it is not possible to specify the communication unit corresponding to the information regarding the communication unit to which the vehicle-mounted ECU to be updated is connected that is acquired from the external server, the vehicle-mounted update device outputs the information including the fact that the communication unit cannot be specified to the external server. Accordingly, when outputting, to the external server, the information indicating the failure to transmit the update program corresponding to the communication unit to which the vehicle-mounted ECU to be updated is connected that is acquired from the external server, the vehicle-mounted update device can also output the cause of the failure included in this information.

### Third Aspect

A configuration is also possible in which, in the vehicle-mounted update device according to a third aspect of the present disclosure, if the control unit cannot receive a response, from the vehicle-mounted ECU to be updated, to output of the update program, the control unit outputs, to the external server, information including a fact that the response from the vehicle-mounted ECU to be updated cannot be received.

With the third aspect, the vehicle-mounted update device tries to receive the response to the output of the update program from the vehicle-mounted ECU to be updated, and in the case of failing to receive the response, the vehicle-mounted update device outputs, to the external server, information including the fact that the response cannot be received from the vehicle-mounted ECU to be updated. Accordingly, when outputting, to the external server, the information indicating the failure to transmit the update program corresponding to the communication unit to which the vehicle-mounted ECU to be updated is connected that is acquired from the external server, the vehicle-mounted update device can also output the cause of the failure included in this information.

### Fourth Aspect

A configuration is also possible in which, in the vehicle-mounted update device according to a fourth aspect of the present disclosure, the communication unit includes a CAN transceiver compatible with a CAN protocol, and the information regarding the communication unit to which the vehicle-mounted ECU to be updated is connected includes information specifying the CAN transceiver.

With the fourth aspect, the communication unit of the vehicle-mounted update device includes the CAN transceiver. In other words, the vehicle-mounted update device functions as a CAN gateway. The information regarding the communication unit to which the vehicle-mounted ECU to be updated is connected that is acquired from the external server, includes information specifying the CAN transceiver, and thus the CAN transceiver to which the vehicle-mounted ECU to be updated is connected can be efficiently specified and the update program can be output from the specified CAN transceiver to the vehicle-mounted ECU to be updated.

### Fifth Aspect

A configuration is also possible in which, in the vehicle-mounted update device according to a fifth aspect of the present disclosure, the communication unit references identification information of the communication units stored in a predetermined storage area, and specifies a communication unit corresponding to the information regarding the communication unit to which the vehicle-mounted ECU to be updated is connected that is acquired from the external server.

With the fifth aspect, the vehicle-mounted update device references the identification information of the communication unit stored in a predetermined storage area, and specifies the communication unit corresponding to the information regarding the communication unit to which the vehicle-mounted ECU to be updated is connected that is acquired from the external server, and thus is able to efficiently specify the corresponding communication unit as well as determining the presence/absence of the communication unit.

### Sixth Aspect

A program according to a sixth aspect of the present disclosure is a program for causing a computer to execute processing for acquiring an update program and information regarding a communication unit to which a vehicle-mounted ECU to be updated is connected, the update program and the information being transmitted from an external server located outside a vehicle, and outputting the update program from the communication unit to which the vehicle-mounted ECU to be updated is connected, based on the acquired information regarding the communication unit to which the vehicle-mounted ECU to be updated is connected.

With the sixth aspect, it is possible to cause a computer to function as the vehicle-mounted update device.

### Seventh Aspect

A program update method according to a seventh aspect of the present disclosure is a program update method for causing a computer to execute processing for acquiring an update program and information regarding a communication unit to which a vehicle-mounted ECU to be updated is connected, the update program and the information being transmitted from the external server located outside a vehicle, and outputting the update program from the communication unit to which the vehicle-mounted ECU to be updated is connected, based on the acquired information regarding the communication unit to which the vehicle-mounted ECU to be updated is connected.

With the seventh aspect, it is possible to provide the program update method according to which, when performing processing for updating the control program of the vehicle-mounted ECU, an increase in the traffic of the communication line to which other vehicle-mounted ECUs are connected is suppressed.

The following specifically describes the present disclosure based on drawings that illustrate embodiments thereof. A vehicle-mounted update device 2 according to the embodiments of the present disclosure will be described below with reference to the drawings. Note that the present disclosure is not limited to the examples, but is indicated by the claims, and is intended to include all modifications within the meaning and scope equivalent to the scope of the claims.

### First Embodiment

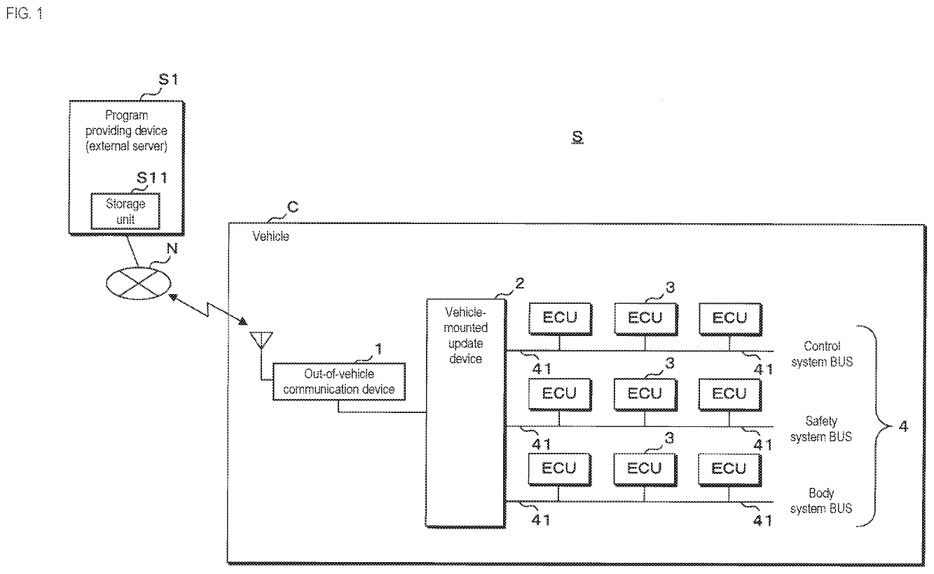

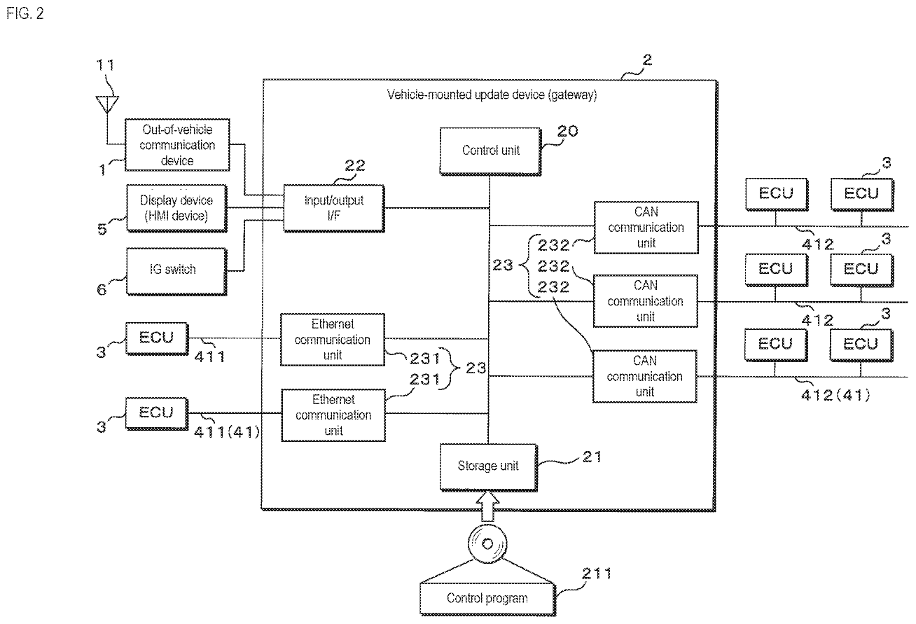

The following describes an embodiment based on the drawings. FIG. 1 is a schematic diagram showing a configuration of a vehicle-mounted update system according to a first embodiment. FIG. 2 is a block diagram showing a configuration of a vehicle-mounted update device 2 and the like. The vehicle-mounted update system S includes an out-of-vehicle communication device 1 and the vehicle-mounted update device 2, which are mounted in a vehicle C, and transmits a program or data acquired from a program providing device S1 that is connected to the vehicle-mounted update system S via an out-of-vehicle network N, to vehicle-mounted ECUs 3 (Electronic Control Units/vehicle-mounted control devices) mounted in the vehicle C.

The program providing device S1 is a computer such as a server connected to the out-of-vehicle network N which is the Internet, a public network or the like, includes a storage unit S11 constituted by a RAM (Random Access Memory), a ROM (Read Only Memory), a hard disk, or the like, and corresponds to an external server located outside the vehicle. A program or data created by the manufacturer or the like of the vehicle-mounted ECUs 3 for controlling the vehicle-mounted ECUs 3 is stored in the storage unit S11 of the program providing device S1. The program or data is transmitted to the vehicle C as an update program, as described later, and used to update the program or data of the vehicle-mounted ECUs 3 mounted in the vehicle C. Further, information for specifying an in-vehicle communication unit 23 of the vehicle-mounted update device 2 to which a vehicle-mounted ECU 3 to be updated by the update program is connected, or the communication line 41 connected to the in-vehicle communication unit 23, is stored in the storage unit S11. The program providing device S1 (external server) configured as above is also referred to as an OTA (Over The Air) server. The vehicle-mounted ECUs 3 mounted in the vehicle acquire the update program transmitted from the program providing device S1 by wireless communication, and apply the update program as the program to be executed, and thus the ECUs can update (re-program) the program to be executed by the ECUs.

In the following description, the program is assumed to include an external file in which program code including control syntaxes and the like for performing processing by the vehicle-mounted ECUs 3 and data that is referenced when executing the program code are described. At the time of transmitting the update program, the external file in which the program code and the data are described is transmitted from the program providing device S1 as an encoded archive file, for example.

An out-of-vehicle communication device 1, the vehicle-mounted update device 2, a display device 5, and the plurality of vehicle-mounted ECUs 3 for controlling various vehicle-mounted devices are mounted in the vehicle C. The out-of-vehicle communication device 1 and the vehicle-mounted update device 2 are communicably connected to each other by a harness such as a serial cable. The vehicle-mounted update device 2 and the vehicle-mounted ECUs 3 are communicably connected to each other via an in-vehicle LAN 4 compatible with a communication protocol such as CAN (Control Area Network/registered trademark) or Ethernet (registered trademark).

The out-of-vehicle communication device 1 includes an out-of-vehicle communicating unit (not shown) and an input/output I/F (interface) (not shown) for communicating with the vehicle-mounted update device 2. The out-of-vehicle communication unit is a communication device for performing wireless communication using a mobile communication protocol such as 3G, LTE, 4G, or Wi-Fi, and transmits and receives data to and from the program providing device S1 via an antenna 11 connected to the out-of-vehicle communication unit. The communication between the out-of-vehicle communication device 1 and the program providing device S1 is performed via an external network such as a public network or the Internet.

An input/output I/F of the out-of-vehicle communication device 1 is a communication interface for performing serial communication with the vehicle-mounted update device 2, for example. The out-of-vehicle communication device 1 and the vehicle-mounted update device 2 communicate with each other via a harness such as a serial cable connected to an input/output I/F 12. In the present embodiment, the out-of-vehicle communication device 1 is a device separate from the vehicle-mounted update device 2, and these devices are communicably connected to each other via the input/output I/F 12 and the like, but there is no limitation to this. The out-of-vehicle communication device 1 may be built in the vehicle-mounted update device 2 as a constituent part of the vehicle-mounted update device 2.

The vehicle-mounted update device 2 includes a control unit 20, a storage unit 21, and an in-vehicle communication unit 23. The vehicle-mounted update device 2 is configured to acquire, from the out-of-vehicle communication device 1, the update program received by the out-of-vehicle communication device 1 from the program providing device S1 by wireless communication, and transmit the update program to a predetermined vehicle-mounted ECU 3 (vehicle-mounted ECU 3 to be updated) via the in-vehicle LAN 4. The vehicle-mounted update device 2 is a gateway (relay device) that generally controls buses (segments) in a plurality of systems such as vehicle-mounted ECUs 3 of a control system, vehicle-mounted ECUs 3 of a safety system, and vehicle-mounted ECUs 3 of a body system, and that relays communication between the vehicle-mounted ECUs 3 between these buses (segments). In other words, the vehicle-mounted update device 2 functions as a CAN gateway in relaying according to the CAN protocol, and functions as a layer 2 switch or a layer 3 switch in relaying according to the TCP/IP protocol. Alternatively, the vehicle-mounted update device 2 may be configured as a functional unit of a body ECU that performs overall control of the vehicle C.

The control unit 20 is constituted by a CPU (Central Processing Unit), an MPU (Micro Processing Unit), or the like, and is configured to perform various kinds of control processing, computational processing, and the like by reading out and executing a control program and data stored in advance in the storage unit 21.

The storage unit 21 is constituted by a volatile memory device such as a RAM (Random Access Memory) or a nonvolatile memory device such as a ROM (Read Only Memory), an EEPROM (Electrically Erasable Programmable ROM), or a flash memory, and a control program and data to be referenced at the time of processing are stored therein in advance. The control program stored in the storage unit 21 may also be a control program read out from a recording medium 211 that can be read by the vehicle-mounted update device 2, and stored in the storage unit 21. Also, the control program may also be a control program downloaded from an external computer (not shown) connected to a communication network (not shown), and stored in the storage unit 21. Further, identification information (communication unit identification table) for identifying and specifying a plurality of Ethernet communication units 231 and CAN communication units 232 included in the in-vehicle communication units 23, which will be described later, is stored in the storage unit 21. The update program acquired from the program providing device S1 and information regarding progress of transmission of the update program to the vehicle-mounted ECU 3 are stored in the storage unit 21.

Relay path information (routing table) used for performing relay processing for communication between the vehicle-mounted ECUs 3, or communication between the vehicle-mounted ECUs 3 and the external server 100 is stored in the storage unit 21. The format of the relay path information is determined based on a communication protocol. When the communication protocol is CAN, CAN relay path information includes a message identifier (CAN-ID) included in a CAN message, and a relay destination (an I/O port number of a CAN communication unit 232) associated with the CAN-ID. When the communication protocol is TCP/IP, TCP/IP relay path information includes a transmission destination address (a MAC address or an IP address) included in an IP packet, and a relay destination (a physical port number of an Ethernet communication unit 231) associated with the transmission destination address.

Similarly to the input/output I/F of the out-of-vehicle communication device 1, an input/output I/F 22 is a communication interface for performing serial communication, for example. The vehicle-mounted update device 2 is communicably connected, via the input/output I/F 22, to the out-of-vehicle communication device 1, the display device 5 (HMI device), and the IG switch 6 for starting and stopping the vehicle C.

The in-vehicle communication unit 23 is, for example, an input/output interface (CAN communication unit 232, Ethernet communication unit 231) using a communication protocol of a CAN (Control Area Network), CAN-FD (CAN with Flexible Data Rate), or Ethernet (registered trademark), and function as communication units for communication between the vehicle-mounted update device 2 and the vehicle-mounted ECUs 3. The in-vehicle communication unit 23 include the CAN communication units 232 and the Ethernet communication units 231.

The CAN communication unit 232 is a CAN transceiver or a CAN-FD transceiver that is compatible with the CAN or CAN-FD communication protocol, and supports CAN messages transmitted on a CAN bus 412. The CAN communication unit 232 receives a waveform resulting from a potential difference between differential voltages on the CAN bus 412, which is formed by two wires respectively disposed on the high side and the low side, and decodes the received waveform into a signal represented by a bit string of 1s and 0s. Alternatively, the CAN communication unit 232 may include the CAN transceiver and a CAN controller, or include the CAN-FD transceiver and a CAN-FD controller.

The Ethernet communication unit 231 is an Ethernet PHY unit that supports TCP/IP packets transmitted with an Ethernet cable 411 such as 100BASE-T1 or 1000BASE-T1.

A plurality of the in-vehicle communication units 23 (Ethernet communication units 231, CAN communication units 232) are provided, and each of the communication lines 41 (Ethernet cable 411, CAN bus 412), or in other words, each of the buses constituting the vehicle-mounted network 4 is connected to each of the in-vehicle communication units 23. By providing a plurality of the in-vehicle communication units 23 in this manner, the vehicle-mounted network 4 may be divided into a plurality of buses (segments), and the vehicle-mounted ECUs 3 may be respectively connected to the segments according to the function of the vehicle-mounted ECUs 3. The control unit 20 of the vehicle-mounted update device 2 mutually communicates with the vehicle-mounted ECUs 3 or other vehicle-mounted devices such as a relay device connected to the in-vehicle network 4 via the in-vehicle communication unit 23.

Similarly to the vehicle-mounted update device 2, the vehicle-mounted ECU 3 includes a control unit (not shown), a storage unit (not shown), and an in-vehicle communication unit (not shown). The storage unit is constituted by a volatile memory device such as a RAM (Random Access Memory) or a nonvolatile memory device such as a ROM (Read Only Memory), an EEPROM (Electrically Erasable Programmable ROM), or a flash memory, and a program or data of the vehicle-mounted ECU 3 is stored therein. The program or data is to be updated by the update program transmitted from the program providing device and relayed by the vehicle-mounted update device 2. Similarly to the vehicle-mounted update device 2, the in-vehicle communication units of the vehicle-mounted ECUs 3 include Ethernet communication units or CAN communication units, and the vehicle-mounted ECUs 3 communicate with the vehicle-mounted update device 2 via the in-vehicle communication units.

The display device 5 is an HMI (Human Machine Interface) device such as a display of a car navigation system, for example. The display device 5 is communicably connected to an input/output I/F 22 of the vehicle-mounted update device 2 via a harness such as a serial cable. The display device 5 displays data or information that is output from the control unit 20 of the vehicle-mounted update device 2 via the input/output I/F 22.

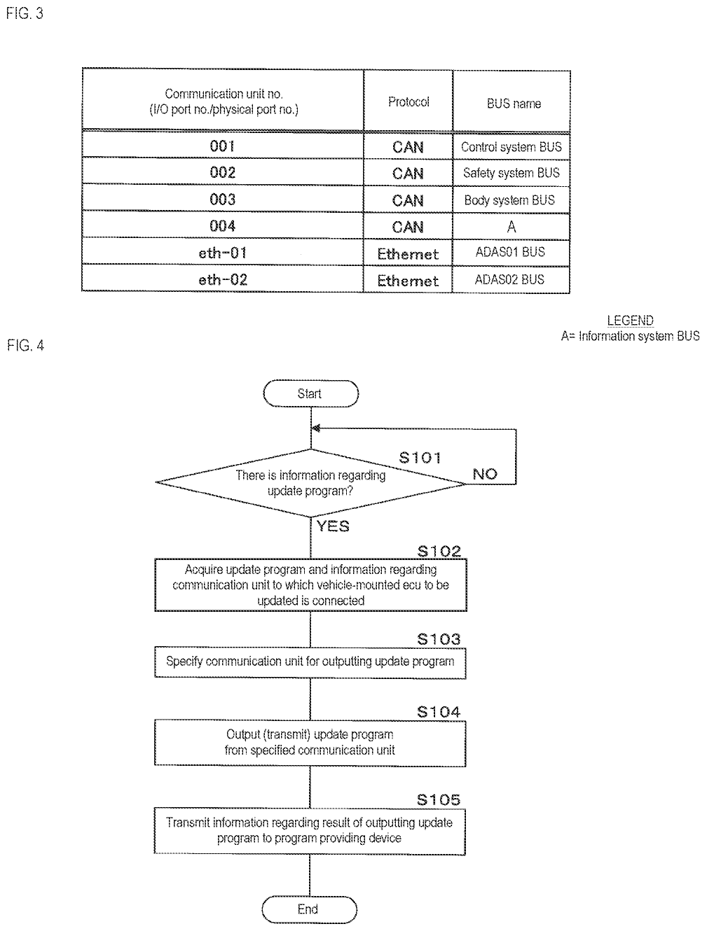

FIG. 3 is a diagram illustrating an aspect of identification information of the in-vehicle communication units 23 (in-vehicle communication unit 23 identification table). Identification information for identifying the plurality of in-vehicle communication units 23 included in the vehicle-mounted update device 2 is stored in the storage unit 21 of the vehicle-mounted update device 2. The identification information is stored in table format as the in-vehicle communication unit 23 identification table, for example, and the in-vehicle communication unit 23 identification table includes communication unit number, protocol, and bus name as the management items.

“Communication unit number” is the number (identification number) for identifying each in-vehicle communication unit 23. If the in-vehicle communication unit 23 is the CAN communication unit 232 (CAN transceiver), for example, the communication unit number indicates the I/O port number, and if the in-vehicle communication unit 23 is the Ethernet communication unit 231 (Ethernet PHY unit), the communication unit number indicates the physical port number. Numbers for identifying the in-vehicle communication units 23 are stored in the field for communication unit numbers (communication unit number field). The control unit 20 of the vehicle-mounted update device 2 can specify the type of the in-vehicle communication unit 23 (the Ethernet communication unit 231 or the CAN communication unit 232) by referencing the communication unit number stored in the communication unit number field.

Information regarding the type of communication protocols (CAN, Ethernet) used by the in-vehicle communication units 23 having the communication unit numbers stored in the communication unit number field is stored in the field for protocols (protocol field). The control unit 20 of the vehicle-mounted update device 2 can grasp the type of communication protocol used by the specified in-vehicle communication unit 23 by referencing the communication unit number stored in the communication unit number field.

Information regarding the name and type of the buses (segments) connected to the in-vehicle communication units 23 of the communication unit numbers stored in the communication unit number field is stored in the field for bus names (bus name field). The control unit 20 of the vehicle-mounted update device 2 can acquire information regarding the name or type of the bus (segment) connected to the specified in-vehicle communication unit 23 by referencing the communication unit number stored in the communication unit number field.

Since the identification information of the in-vehicle communication unit 23 is stored in table format as the in-vehicle communication unit 23 identification table, the control unit 20 of the vehicle-mounted update device 2 can search for the communication unit number of the in-vehicle communication unit 23 corresponding to the value of “bus name”, based on the value of “bus name”.

The identification information of the in-vehicle communication unit 23 (in-vehicle communication unit 23 identification table) is stored in the storage unit 21 of the vehicle-mounted update device 2, but there is no limitation to this. The identification information (in-vehicle communication units 23 identification table) of the in-vehicle communication units 23 may also be stored in a predetermined storage area, which is accessible by the vehicle-mounted update device 2, such as a storage unit of one of the vehicle-mounted ECUs mounted in the vehicle C, or the storage unit of a cloud server provided outside of the vehicle C such as the program providing device S1.

The vehicle-mounted update device 2 communicates with the program providing device S1 via the out-of-vehicle communication device 1, and when acquiring the update program from the program providing device S1, also acquires information regarding the in-vehicle communication unit 23 to which the vehicle-mounted ECU 3 to be updated is connected. The vehicle-mounted update device 2 specifies one of the in-vehicle communication units 23 in the own device based on information regarding the in-vehicle communication unit 23 acquired from the program providing device S1, for example, by referencing the in-vehicle communication unit 23 identification table stored in the storage unit 21.

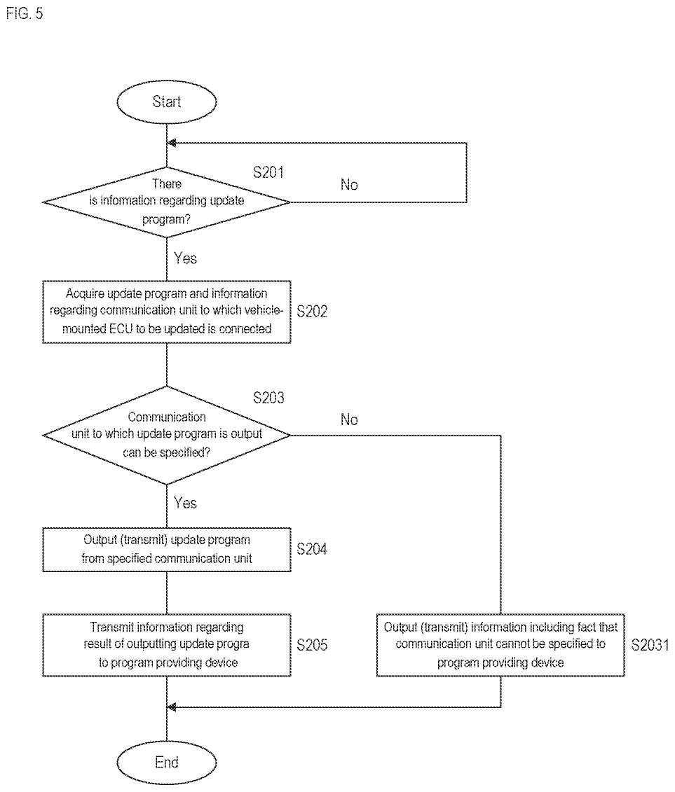

FIG. 4 is a flowchart illustrating processing performed by the control unit 20 of the vehicle-mounted update device 2. The control unit 20 of the vehicle-mounted update device 2 steadily performs the following processing in the state where the vehicle C has been started (the IG switch 6 is ON) or stopped (where IG switch 6 is OFF).

The control unit 20 of the vehicle-mounted update device 2 determines whether there is information regarding the update program (S101). The control unit 20 communicates with the program providing device S1 via the out-of-vehicle communication device 1, inquires whether there is information regarding the update program, and determines whether there is information regarding the update program such as campaign information. Determination of whether there is information regarding the update program may also be performed not only by pull-type communication through an inquiry from the vehicle-mounted update device 2 to the program providing device S1, but also based on push-type communication through a message or the like transmitted from the program providing device S1 to the vehicle-mounted update device 2.

If there is no information regarding the update program (S101: NO), the control unit 20 of the vehicle-mounted update device 2 performs loop processing in order to execute the processing of S101 again. By performing the loop processing, the control unit 20 of the vehicle-mounted update device 2 periodically performs an inquiry about whether there is information regarding the update program to the program providing device S1.

If there is information regarding the update program (S101: YES), the control unit 20 of the vehicle-mounted update device 2 acquires the update program and information regarding the in-vehicle communication unit 23 to which the vehicle-mounted ECU 3 to be updated is connected (S102). When acquiring the update program from the program providing device S1, the control unit 20 acquires information regarding the in-vehicle communication unit 23 to which the vehicle-mounted ECU 3 to be updated is connected, together with the update program. The control unit 20 may also acquire the information regarding the in-vehicle communication unit 23 to which the vehicle-mounted ECU 3 to be updated is connected, separately from the update program. Alternatively, if the information regarding the in-vehicle communication unit 23 to which the vehicle-mounted ECU 3 to be updated is connected is provided as archived data included in the update program, the control unit 20 acquires and develops the archived update program (archived data) and acquires the information regarding the in-vehicle communication unit 23 to which the vehicle-mounted ECU 3 to be updated is connected. The control unit 20 saves the acquired update program in the storage unit 21.

The control unit 20 of the vehicle-mounted update device 2 specifies the in-vehicle communication unit 23 for outputting the update program (S103). The control unit 20 specifies the in-vehicle communication unit 23 included in the own device based on the acquired information regarding the in-vehicle communication unit 23 to which the vehicle-mounted ECU 3 to be updated is connected. For example, if the information regarding the in-vehicle communication unit 23 to which the vehicle-mounted ECU 3 to be updated is connected that is acquired from the program providing device S1 includes the communication unit number that uniquely specifies the in-vehicle communication unit 23, the control unit 20 specifies the in-vehicle communication unit 23 in the own device based on that communication unit number. The control unit 20 may also specify the in-vehicle communication unit 23 corresponding to the acquired information regarding the in-vehicle communication unit 23 to which the vehicle-mounted ECU 3 to be updated is connected, by referencing the identification information of the in-vehicle communication units 23 (communication unit identification table) stored in the storage unit 21. For example, if the information regarding the in-vehicle communication unit 23 to which the vehicle-mounted ECU 3 to be updated is connected that is acquired from the program providing device S1 includes the items regarding the name or type (bus name) of the bus connected to that in-vehicle communication unit 23, the control unit 20 may also reference the communication unit identification table, conduct reverse lookup search for the communication unit number from the bus name, and derive the communication unit number of the in-vehicle communication unit 23.

The control unit 20 of the vehicle-mounted update device 2 outputs (transmits) the update program from the specified in-vehicle communication unit 23 (S104). The control unit 20 transmits the update program from the specified in-vehicle communication unit 23 to the vehicle-mounted ECU 3 to be updated by outputting the update program that is acquired from the program providing device S1 and temporarily saved in the storage unit 21. The control unit 20 outputs the update program only from the specified in-vehicle communication unit 23, thus making it possible to suppress an increase in the traffic (bus load) of the communication lines 41 (buses) connected to the in-vehicle communication units 23 other than the specified in-vehicle communication unit 23.

The control unit 20 of the vehicle-mounted update device 2 transmits information regarding the result of outputting the update program to the program providing device S1 (S105). The control unit 20 transmits (outputs), to the program providing device S1, for example, information indicating the date and time when the update program is transmitted to the vehicle-mounted ECU 3 to be updated, the result of response received from the vehicle-mounted ECU 3 to be updated as the result of transmission, or the fact indicating that the update processing has been normally performed, as information regarding the result of outputting the update program, via the out-of-vehicle communication device 1. The control unit 20 may also output, to the display device 5, the information regarding the result of outputting the update program. Due to the control unit 20 outputting the information regarding the result of outputting the update program to the program providing device S1 or the display device 5, the information can be notified to the administrator of the program providing device S1 or the operator of the vehicle C.

According to the present embodiment, the vehicle-mounted update device 2 outputs the update program from the in-vehicle communication unit 23 (the in-vehicle communication unit 23 to which the vehicle-mounted ECU 3 to be updated is connected) based on the information regarding the in-vehicle communication unit 23 acquired from the program providing device S1. Accordingly, it is possible to eliminate the need to output the update program from the in-vehicle communication units 23 other than the in-vehicle communication unit 23 to which the vehicle-mounted ECU 3 to be updated is connected. Also, an increase in the traffic (bus load) of the communication lines 41 connected to the in-vehicle communication unit 23 can be suppressed, and the update program can be efficiently output (transmitted) to the vehicle-mounted ECU 3 to be updated. Further, since the information for specifying the in-vehicle communication unit 23 to which the vehicle-mounted ECU 3 to be updated is connected is the information transmitted from the program providing device S1 together with the update program, the vehicle-mounted update device 2 can acquire the information for which the association between the update program and the in-vehicle communication unit 23 to which the vehicle-mounted ECU 3 to be updated is connected is ensured.

### Second Embodiment

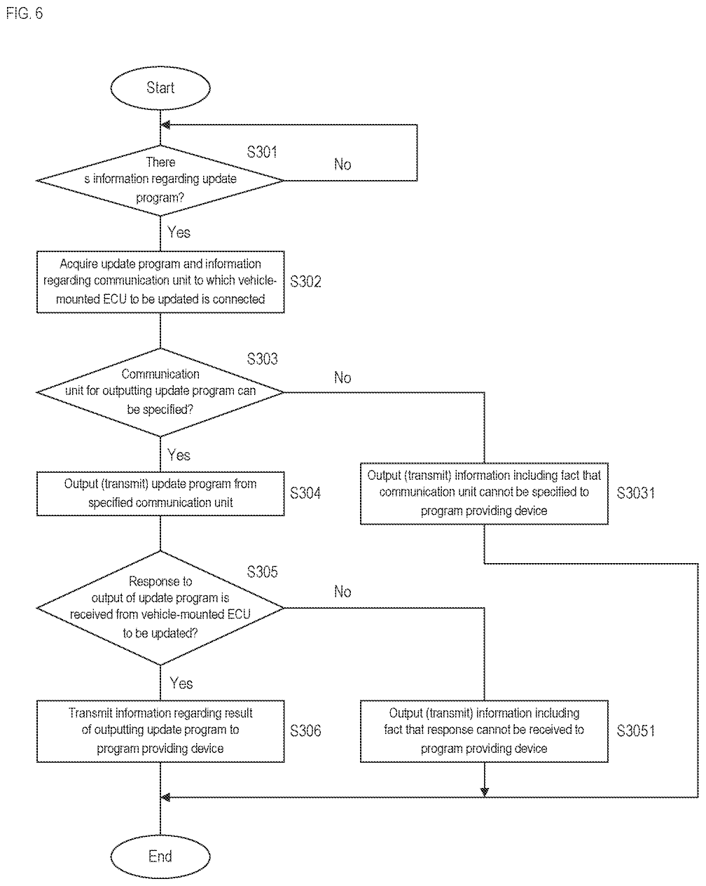

FIG. 5 is a flowchart illustrating processing performed by a control unit 20 of a vehicle-mounted update device 2 according to a second embodiment. The control unit 20 of the vehicle-mounted update device 2 steadily performs the following processing in the state where the vehicle C has been started (the IG switch 6 is ON) or stopped (the IG switch 6 is OFF).

The control unit 20 of the vehicle-mounted update device 2 determines whether there is information regarding the update program (S201). If there is no information regarding the update program (S201: NO), the control unit 20 of the vehicle-mounted update device 2 performs loop processing in order to execute processing of S201 again. If there is the information regarding the update program (S201: YES), the control unit 20 of the vehicle-mounted update device 2 acquires the update program and information regarding the in-vehicle communication unit 23 to which the vehicle-mounted ECU 3 to be updated is connected (S202). The control unit 20 performs the processing of S201 and S202 similarly to the processing of S101 and S102 of the first embodiment.

The control unit 20 of the vehicle-mounted update device 2 determines whether the in-vehicle communication unit 23 for outputting the update program has been specified (S203). The control unit 20 compares the information regarding the in-vehicle communication unit 23 to which the vehicle-mounted ECU 3 to be updated is connected that is acquired from the program providing device S1 with the identification information of the in-vehicle communication units 23 (communication unit identification table) stored in the storage unit 21, for example. The control unit 20 determines whether the in-vehicle communication unit 23 that is included in the information acquired from the program providing device S1 exists in the own device, that is, whether the in-vehicle communication unit 23 corresponds to any of the in-vehicle communication units 23 provided in the own device, based on the comparison result.

If the in-vehicle communication unit 23 that is included in the information acquired from the program providing device S1 exists in the own device, the control unit 20 specifies the in-vehicle communication unit 23 for outputting the update program similarly to the processing of S103 of the first embodiment, and determines that the in-vehicle communication unit 23 can be specified.

If the in-vehicle communication unit 23 included in the information acquired from the program providing device S1 does not exist in the own device, the control unit 20 determines that the in-vehicle communication unit 23 for outputting the update program cannot be specified. The case where the in-vehicle communication unit 23 cannot be specified is as follows. For example, the in-vehicle communication unit 23 included in the information acquired from the program providing device S1 indicates the communication unit number (I/O port number) of “007” of the CAN communication unit 232. However, in this case, the CAN communication unit 232 whose communication unit number is “007” is not included in the information stored in the communication unit identification table, and the vehicle-mounted update device 2 is not provided with the CAN communication unit 232 whose communication unit number is “007”.

If the in-vehicle communication unit 23 for outputting the update program cannot be specified (S203:NO), the control unit 20 of the vehicle-mounted update device 2 outputs (transmits), to the program providing device S1, information including the fact that the in-vehicle communication unit 23 to which the vehicle-mounted ECU 3 to be updated is connected cannot be specified (S2031). If the in-vehicle communication unit 23 for outputting the update program cannot be specified, that is, if the in-vehicle communication unit 23 included in the information acquired from the program providing device S1 does not exist in the own device, the control unit 20 outputs (transmits), to the program providing device S1, the information including the fact that the in-vehicle communication unit 23 to which the vehicle-mounted ECU 3 to be updated is connected cannot be specified. Further, the control unit 20 may also output (transmit) the information to the display unit. When outputting (transmitting) the information to the program providing device S1, the control unit 20 may also output (transmit), to the program providing device S1, the fact that the in-vehicle communication unit 23 included in the information transmitted from the program providing device S1 does not exist in the own device. Alternatively, when outputting (transmitting) the information to the program providing device S1, the control unit 20 may also output (transmit) the information regarding the communication unit identification table to the program providing device S1.

If the in-vehicle communication unit 23 for outputting the update program can be specified (S203: YES), the control unit 20 of the vehicle-mounted update device 2 outputs (transmits) the update program from the specified in-vehicle communication unit 23 (S204). The control unit 20 of the vehicle-mounted update device 2 transmits, to the program providing device S1, the information regarding the result of outputting the update program (S205). The control unit 20 performs the processing of S204 and S205 similarly to the processing of S104 and S105 of the first embodiment.

According to the present embodiment, if the communication unit corresponding to the information regarding the communication unit to which the vehicle-mounted ECU to be updated is connected that is acquired from the program providing device S1 cannot be specified, the vehicle-mounted update device 2 outputs, to the program providing device S1, information indicating the fact that the corresponding communication unit cannot be specified, including the cause which is that the corresponding communication unit does not exist in the own device. Accordingly, the fact that the application (activation) of the update program to the vehicle-mounted ECU 3 failed, including the cause of the failure of transmission of the update program, can be output (transmitted) to the program providing device S1.

### Third Embodiment

FIG. 6 is a flowchart illustrating processing performed by a control unit 20 of a vehicle-mounted update device 2 according to a third embodiment. The control unit 20 of the vehicle-mounted update device 2 steadily performs the following processing in the state where the vehicle C has been started (the IG switch 6 is ON) or stopped (the IG switch 6 is OFF).

The control unit 20 of the vehicle-mounted update device 2 determines whether there is information regarding the update program (S301). If there is no information regarding the update program (S301: NO), the control unit 20 of the vehicle-mounted update device 2 performs loop processing in order to execute processing of S301 again. If there is information regarding the update program (S301: YES), the control unit 20 of the vehicle-mounted update device 2 acquires the update program and information regarding the in-vehicle communication unit 23 to which the vehicle-mounted ECU 3 to be updated is connected (S302). The control unit 20 performs the processing of S301 and S302 similarly to the processing of S101 and S102 of the first embodiment.

The control unit 20 of the vehicle-mounted update device 2 determines whether the in-vehicle communication unit 23 for outputting the update program can be specified (S303). If the in-vehicle communication unit 23 for outputting the update program cannot be specified (S303:NO), the control unit 20 of the vehicle-mounted update device 2 outputs (transmits), to the program providing device S1, information including the fact that the in-vehicle communication unit 23 to which the vehicle-mounted ECU 3 to be updated is connected cannot be specified (S3031). If the in-vehicle communication unit 23 for outputting the update program can be specified (S303: YES), the control unit 20 of the vehicle-mounted update device 2 outputs (transmits) the update program from the specified in-vehicle communication unit 23 (S304). The control unit 20 performs the processing of S303, S3031, and S304 similarly to the processing of S203, S2031, and S204 of the second embodiment.

The control unit 20 of the vehicle-mounted update device 2 determines whether the response to the output of the update program can be received from the vehicle-mounted ECU 3 to be updated (S305). After outputting (transmitting) the update program from the specified in-vehicle communication unit 23, the control unit 20 tries to receive the response from the vehicle-mounted ECU 3 (the vehicle-mounted ECU 3 to be updated) that is the transmission destination of the update program. In other words, the control unit 20 waits for the response from the vehicle-mounted ECU 3 to be updated.

If the response from the vehicle-mounted ECU 3 to be updated can be received (acquired), the control unit 20 determines that the response to the output of the update program can be received. If the response from the vehicle-mounted ECU 3 to be updated cannot be received (acquired), the control unit 20 determines that the response to the output of the update program cannot be received in a predetermined period that is determined in advance by the communication protocol, for example.

If the response from the vehicle-mounted ECU 3 to be updated cannot be received (S305: NO), the control unit 20 of the vehicle-mounted update device 2 outputs (transmits), to the program providing device S1, information including the fact that the response from the vehicle-mounted ECU 3 to be updated cannot be received (S3051). If the response from the vehicle-mounted ECU 3 to be updated cannot be received, the control unit 20 outputs (transmits), to the program providing device S1, information indicating the fact that the vehicle-mounted ECU 3 to be updated is not connected to the communication line 41 (bus) that is connected to the in-vehicle communication unit 23 included in the information transmitted from the program providing device S1, for example. Further, the control unit 20 may also output (transmit) the information to the display unit.

If the response from the vehicle-mounted ECU 3 to be updated can be received (S305: YES), the control unit 20 transmits, to the program providing device S1, information regarding the output result of the update program (S306). The control unit 20 performs the processing of S306 similarly to the processing of S105 of the first embodiment.

According to the present embodiment, if the response to the output of the update program cannot be received from the vehicle-mounted ECU 3 to be updated, the vehicle-mounted update device 2 outputs, to the program providing device S1, the information including the fact that the vehicle-mounted ECU 3 to be updated is not connected to the communication line 41 (bus) that is connected to the in-vehicle communication unit 23 included in the information transmitted from the program providing device S1, for example. Accordingly, the fact that the application (activation) of the update program to the vehicle-mounted ECU 3 failed, including the cause of the failure in transmission of the update program, can be output (transmitted) to the program providing device S1.

The embodiments in the present disclosure are examples in all aspects, and should be construed as non-limiting. The scope of the present disclosure is not limited to the above meanings, but is indicated by the claims, and is intended to include all modifications within the meaning and scope equivalent to the scope of the claims.

1. A vehicle-mounted update device for acquiring an update program transmitted from an external server located outside a vehicle, and performing processing for updating a program of a vehicle-mounted ECU mounted in the vehicle, the vehicle-mounted update device comprising:
a control unit configured to control transmission of the update program; and
a plurality of communication units to which the vehicle-mounted ECU is connected,
wherein the control unit
when acquiring the update program, acquires information regarding a communication unit to which a vehicle-mounted ECU to be updated is connected from the external server, and
outputs the update program from the communication unit to which the vehicle-mounted ECU to be updated is connected, based on the acquired information regarding the communication unit to which the vehicle-mounted ECU to be updated is connected.

2. The vehicle-mounted update device according to claim 1, wherein, if the communication unit corresponding to the information regarding the communication unit to which the vehicle-mounted ECU to be update is connected that is acquired from the external server cannot be specified out of the plurality of communication units, the control unit outputs, to the external server, information including a fact that the communication unit to which the vehicle-mounted ECU to be updated is connected cannot be specified.

3. The vehicle-mounted update device according to claim 1, wherein, if the control unit cannot receive a response, from the vehicle-mounted ECU to be updated, to output of the update program, the control unit outputs, to the external server, information including a fact that the response from the vehicle-mounted ECU to be updated cannot be received.

4. The vehicle-mounted update device according to claim 1, wherein the communication unit includes a CAN transceiver compatible with a CAN protocol, and
the information regarding the communication unit to which the vehicle-mounted ECU to be updated is connected includes information specifying the CAN transceiver.

5. The vehicle-mounted update device according to claim 1, wherein the communication unit references identification information of the communication units stored in a predetermined storage area, and specifies a communication unit corresponding to the information regarding the communication unit to which the vehicle-mounted ECU to be updated is connected that is acquired from the external server.

6. A program for causing a computer to execute processing for:
acquiring an update program and information regarding a communication unit to which a vehicle-mounted ECU to be updated is connected, the update program and the information being transmitted from an external server located outside a vehicle; and
outputting the update program from the communication unit to which the vehicle-mounted ECU to be updated is connected, based on the acquired information regarding the communication unit to which the vehicle-mounted ECU to be updated is connected.

7. A program update method for causing a computer to execute processing for:
acquiring an update program and information regarding a communication unit to which a vehicle-mounted ECU to be updated is connected, the update program and the information being transmitted from the external server located outside a vehicle; and
outputting the update program from the communication unit to which the vehicle-mounted ECU to be updated is connected, based on the acquired information regarding the communication unit to which the vehicle-mounted ECU to be updated is connected.

8. The vehicle-mounted update device according to claim 2, wherein, if the control unit cannot receive a response, from the vehicle-mounted ECU to be updated, to output of the update program, the control unit outputs, to the external server, information including a fact that the response from the vehicle-mounted ECU to be updated cannot be received.

9. The vehicle-mounted update device according to claim 2, wherein the communication unit includes a CAN transceiver compatible with a CAN protocol, and
the information regarding the communication unit to which the vehicle-mounted ECU to be updated is connected includes information specifying the CAN transceiver.

10. The vehicle-mounted update device according to claim 3, wherein the communication unit includes a CAN transceiver compatible with a CAN protocol, and
the information regarding the communication unit to which the vehicle-mounted ECU to be updated is connected includes information specifying the CAN transceiver.

11. The vehicle-mounted update device according to claim 2, wherein the communication unit references identification information of the communication units stored in a predetermined storage area, and specifies a communication unit corresponding to the information regarding the communication unit to which the vehicle-mounted ECU to be updated is connected that is acquired from the external server.

12. The vehicle-mounted update device according to claim 3, wherein the communication unit references identification information of the communication units stored in a predetermined storage area, and specifies a communication unit corresponding to the information regarding the communication unit to which the vehicle-mounted ECU to be updated is connected that is acquired from the external server.

13. The vehicle-mounted update device according to claim 4, wherein the communication unit references identification information of the communication units stored in a predetermined storage area, and specifies a communication unit corresponding to the information regarding the communication unit to which the vehicle-mounted ECU to be updated is connected that is acquired from the external server.
